(19) United States
(12) Patent Application Publication
(10) Pub. No.: US 2026/0205521 A1
(43) Pub. Date: Jul. 16, 2026

(54) System And Method For Application and Session-Specific Tagging in Internet Protocol (IP) Packets

(71) Applicant: Charter Communications Operating, LLC, St. Louis, MO (US)

(72) Inventors: Patrick Phillip HUNTER, Saint Charles, MO (US); Lawrence Antonio WASHINGTON, Ballwin, MO (US)

(21) Appl. No.: 19/018,310

(22) Filed: Jan. 13, 2025

(51) Int. Cl. H04L 67/146; H04L 9/40; H04L 45/00; H04L 45/302; H04L 69/22

(52) U.S. Cl. CPC H04L 67/146; H04L 45/306; H04L 45/566; H04L 63/0442; H04L 69/22

(57) ABSTRACT

Systems and methods for tagging Internet Protocol (IP) packets with application-specific and session-specific information in a network communication system. A processing system within a network node may analyze IP packet headers and payloads to generate tags identifying the associated application and session. These tags may be embedded in the packet header or payload through modifications to standard protocols, such as RFC 8200 for IPv6 and RFC 791 for IPv4. This tagging allows enhanced traffic classification, real-time analysis, and more efficient routing by network devices. The system may use detailed packet-level metadata to improve network security, detect anomalies, prioritize traffic, and prevent unauthorized access. The system may enhance network performance, reduce latency, and improve network management in complex environments by streamlining packet handling across network components, including routers, firewalls, and switches.

### BACKGROUND

Internet Protocol (IP) is a widely used method for transmitting data across networks in which packets of information are routed between clients and servers based on source and destination IP addresses. IP packets are structured according to specific protocol standards (e.g., IPv4, IPv6, etc.) that define how routing, addressing, and packet processing are handled within the network. The transmission of data across the network may be managed at multiple layers, including the application, transport, and network layers, which cooperate to ensure efficient and secure delivery.

At the network layer, protocols such as IPv6 (as described in RFC 8200) and IPv4 (as described in RFC 791) play an important role in routing packets between endpoints. These protocols define packet structures, including headers that contain information such as traffic classes, flow labels, and other information that may be used for managing the flow of traffic and correctly routing packets. Techniques such as traffic classification, flow labeling (described in RFC 6437), and encryption using public and private key mechanisms may be used to maintain security and quality of service within communication systems.

In parallel, the higher-level network layer, particularly at the transport and application layers, provides additional capabilities such as session management and application-specific data handling. These layers allow network devices to establish and maintain secure connections, assign session identifiers, and track the flow of data between applications and services. The integration of encryption techniques, such as hashing and public/private key exchanges, at various layers may protect sensitive data as the sensitive data moves across the network. In addition, databases and servers play an important role in managing, storing, and retrieving metadata and tags that may be associated with specific traffic flows and further aid in the classification and analysis of network activity.

The growth of modern networked environments has led to an increasing desire for granular traffic analysis and management. This desire has driven the development of advanced techniques for inspecting and categorizing data flows based on application-specific and session-specific attributes. Such techniques may allow network administrators to monitor traffic, identify performance bottlenecks, and maintain robust security protocols across distributed systems. Despite these solutions, there remains a need for more sophisticated native solutions within IP networks that are capable of supporting more detailed tagging and classification of traffic at the packet level.

### SUMMARY

The various aspects include methods of tagging Internet Protocol (IP) packets with application-specific and session-specific information in a network communication system, which may include receiving a data packet from a client or server, extracting header information from the received data packet, and determining whether the received data packet includes an application-specific tag or session-specific tag.

Some aspects of the method may further include the operations in which in response to determining that the received data packet does not include the application-specific tag or session-specific tag: analyzing the received data packet to determine an application-specific context and session-specific context based on source and destination IP addresses, transport layer port numbers, and payload content; assigning a new application-specific tag or a new session-specific tag to the received data packet; updating the received data packet with the assigned application-specific tag or session-specific tag; determining an appropriate processing route based on the assigned application-specific tag or session-specific tag; and sending the received data packet to its intended destination using the determined processing route.

In some aspects of the method, extracting header information from the received data packet comprises extracting a source IP address, a destination IP address, a traffic class, and flow label fields from the received data packet. In some aspects of the method, the received data packet is an IPv6 data packet; and updating the received data packet with the assigned application-specific tag or session-specific tag comprises: concatenating traffic class and flow label fields in an IPv6 header of the received data packet. In some aspects of the method, updating the received data packet with the assigned application-specific tag or session-specific tag comprises: adding an extension header that includes the application-specific tag or the session-specific tag to the received data packet. In some aspects of the method, updating the received data packet with the assigned application-specific tag or session-specific tag comprises: inserting the application-specific tag or the session-specific tag into initial bytes of an IP packet payload of the received data packet. In some aspects of the method, the method may further include: initializing network configuration settings and data structures for tracking application-specific tags, session-specific tags, and flow metadata; and establishing connections with key servers for encryption and secure assignment and validation of application-specific tags and session-specific tags. In some aspects of the method, the method may further include: using a public/private key mechanism to verify integrity and source of the received data packet before determining whether the received data packet includes an application-specific tag or session-specific tag. In some aspects of the method, the method may further include: using an encryption protocol to secure the received data packet before determining whether the received data packet includes an application-specific tag or session-specific tag. In some aspects of the method, the method may further include: updating session states and flow metadata with the application-specific tag or session-specific tag for tracking ongoing sessions. In some aspects of the method, the method may further include: tracking ongoing sessions and their corresponding application-specific tag or session-specific tags.

Some aspects of the method may further include in response to determining that the received data packet includes the application-specific tag or session-specific tag: validating the application-specific tag or session-specific tag against a predefined table of valid application-specific tags and session-specific tags; and extracting metadata associated with the validated application-specific tag or the validated session-specific tag.

In some aspects of the method, the method may further include: determining an appropriate processing route based on the extracted metadata; and sending the received data packet to its intended destination using the determined processing route. In some aspects of the method, the method may further include: performing a security check based on the extracted metadata to verify an authenticity or an integrity of the data packet in response to determining that the received data packet includes the application-specific tag or session-specific tag. In some aspects of the method, extracting header information from the received data packet comprises extracting a source IP address, a destination IP address, a traffic class, and flow label fields from the received data packet. In some aspects of the method, the received data packet is an IPv6 data packet. In some aspects of the method, the method may further include: initializing network configuration settings and data structures for tracking application-specific tags, session-specific tags, and flow metadata; and establishing connections with key servers for encryption and secure assignment and validation of application-specific tags and session-specific tags. In some aspects of the method, the method may further include: using a public/private key mechanism to verify integrity and source of the received data packet before determining whether the received data packet includes the application-specific tag or session-specific tag. In some aspects of the method, the method may further include: using an encryption protocol to secure the received data packet before determining whether the received data packet includes the application-specific tag or session-specific tag. In some aspects of the method, the method may further include: tracking ongoing sessions and their corresponding application-specific or session-specific tags.

Further aspects may include a network node or computing system having at least one processor or processing system configured with processor-executable instructions to perform various operations corresponding to the methods discussed above. Further aspects may include a computing device having various means for performing functions corresponding to the method operations discussed above. Further aspects may include a non-transitory processor-readable storage medium having stored thereon processor-executable instructions configured to cause at least one processor or processing system to perform various operations corresponding to the method operations discussed above.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention.

FIGS. 1A and 1B are block diagrams of an example network according to various embodiments disclosed herein.

FIG. 2 is a component block diagram illustrating example components that could be included in a network or computing system configured to implement various embodiments disclosed herein.

FIGS. 3A and 3B are process flow diagrams that illustrate a method of tagging IP packets with application-specific and/or session-specific tags in accordance with various embodiments disclosed herein.

FIG. 4 is a component diagram of a system on chip (SOC) suitable for implementing various embodiments disclosed herein.

FIG. 5 is a component diagram of a server suitable for implementing various embodiments disclosed herein.

### DETAILED DESCRIPTION

The various embodiments may be described in detail with reference to the accompanying drawings. When possible, the same reference numbers may be used throughout the drawings to refer to the same or like parts. References made to particular examples and implementations are for illustrative purposes and are not intended to limit the scope of the invention or the claims.

In overview, the embodiments include methods, and computing systems configured to implement the methods, for tagging Internet Protocol (IP) packets with application-specific and/or session-specific information in a network communication system. A processing system in a network computing device may be configured to receive IP packets, analyze their headers and payloads, and assign tags that identify the particular application and/or session associated with each packet. In some embodiments, the processing system may generate the application-specific and/or session-specific tags by concatenating the traffic class and flow label fields or by adding extension headers to IPv6 packets. The processing system may embed the generated tags in the IP packet headers or insert them into the packet payloads by using modified protocol standards, such as those outlined in RFC 8200 for IPv6 or RFC 791 for IPv4. Such tagging may allow the network device to associate metadata with the packet flow for more detailed tracking, analysis, and routing of network traffic.

Various embodiments disclosed herein overcome various limitations of related solutions by modifying IP headers and payloads to allow for the assignment of tags that may be processed by network devices and/or which allow for the differentiation of traffic types, identification of performance bottlenecks, and prevention of security threats such as unauthorized access or data interception. By providing more precise tagging and classification of network traffic, various embodiments may enhance network efficiency, reduce latency, and improve the ability of network devices to manage high volumes of traffic in complex environments. The embodiments may also improve network security by offering detailed packet-level visibility to allow for quicker detection and response to anomalies or potential threats. For all the above reasons, the embodiments may improve the performance and functioning of the networks and computing devices on which they are implemented. Additional improvements to the performance and functioning of the devices will be evident from the disclosures below.

The term “service provider network” is used generically herein to refer to any network suitable for providing consumers with access to the Internet or IP services over broadband connections and may encompass both wired and wireless networks/technologies. Examples of wired network technologies and networks that may be included within a service provider network include cable networks, fiber optic networks, hybrid-fiber-coax (HFC) networks, Ethernet, local area networks (LAN), metropolitan area networks (MAN), wide area networks (WAN), networks that implement the data over cable service interface specification (DOCSIS), networks that utilize asymmetric digital subscriber line (ADSL) technologies, etc. Examples of wireless network technologies and networks that may be included within a service provider network include third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), high-speed downlink packet access (HSDPA), 3GSM, general packet radio service (GPRS), code division multiple access (CDMA) systems (e.g., cdmaOne, CDMA2000TM), enhanced data rates for GSM evolution, advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), Bluetooth®, land mobile radio (LMR), and integrated digital enhanced network (iden). Each of these wired and wireless technologies includes, for example, the transmission and reception of data, signaling and/or content messages.

Any references to terminology and/or technical details related to an individual wired or wireless communications standard or technology are for illustrative purposes only, and not intended to limit the scope of the claims to a particular communication system or technology unless specifically recited in the claim language.

The term “user equipment (UE)” may be used herein to refer to any one or all of satellite or cable set top boxes, laptop computers, rack mounted computers, routers, cellular telephones, smart phones, personal or mobile multi-media players, personal data assistants (PDAs), customer-premises equipment (CPE), personal computers, tablet computers, smart books, palm-top computers, desk-top computers, wireless electronic mail receivers, multimedia Internet enabled cellular telephones, wireless gaming controllers, streaming media players (such as, ROKU™), smart televisions, digital video recorders (DVRs), modems, routers, network switches, residential gateways (RG), access nodes (AN), bridged residential gateway (BRG), fixed mobile convergence products, home networking adapters and Internet access gateways that enable consumers to access communications service providers’ services and distribute them around their house via a local area network (LAN), and similar electronic devices which include a programmable processor and memory and circuitry for providing the functionality described herein.

The terms “component,” “system,” and the like may be used herein to refer to a computer-related entity (e.g., hardware, firmware, a combination of hardware and software, software, software in execution, etc.) that is configured to perform particular operations or functions. For example, a component may be, but is not limited to, a process running on a processor, a processor, an object, an executable, a thread of execution, a program, and/or a computing device. By way of illustration, both an application running on a computing device and the computing device may be referred to as a component. One or more components may reside within a process and/or thread of execution, and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process-related communication methodologies.

The term “processing system” may be used herein to refer to one or more processors, including multi-core processors, that are organized and configured to perform various computing functions. A processing system may implement various embodiment methods using one or more of its processors as described herein.

The term “system on chip” (SoC) may be used herein to refer to a single integrated circuit (IC) that contains multiple resources or independent processors integrated on a single substrate. An SoC may include digital, analog, mixed-signal, and radio-frequency circuitry, general-purpose or specialized processors (e.g., network processors, digital signal processors, modem processors, video processors, etc.), memory blocks (e.g., ROM, RAM, Flash, etc.), and other resources (e.g., timers, voltage regulators, oscillators, etc.). Examples of processors in an SoC may include central processing units (CPUs), microprocessor units (MPUs), or arithmetic logic units (ALUs), and a SoC may also include software for controlling integrated resources and peripheral devices.

The term “system in a package” (SiP) may be used herein to refer to a single module or package that contains multiple resources, computational units, cores, or processors on two or more IC chips, substrates, or SoCs. A SiP may include vertically stacked semiconductor dies or multiple ICs packaged into a unifying substrate. A SiP may also include multiple independent SoCs coupled via high-speed communication circuitry and packaged in close proximity, such as in a single motherboard or user equipment (UE).

The term “network node” may be used herein to refer to any computing device, system, or infrastructure component that facilitates communication within a network. Network nodes may include, but are not limited to, routers, switches, gateways, access points, modems, base stations, hubs, servers, repeaters, bridges, and other network components that transmit, receive, process, or route data packets across wired or wireless communication networks. A network node may serve various roles, such as managing data traffic, providing routing services, connecting network segments, or supporting user equipment (UE) access to a service provider network. Network nodes may operate at different layers of the Open Systems Interconnection (OSI) model, including the physical, data link, network, or transport layers, and may include hardware and software resources configured to perform specific network functions. A network node may also be implemented as part of a distributed network or cloud infrastructure in which nodes collaborate to handle distributed tasks or workloads across multiple locations.

The term “Open Systems Interconnection (OSI) model” may be used herein to refer to a technical framework that standardizes the functions of a telecommunication or computing system without regard to its underlying internal structure and technology. The OSI model may divide a communication system into seven layers: the physical, data link, network, transport, session, presentation, and application layers. Network nodes that implement these layers allow interoperability between diverse communication systems through standardized protocols and processes for efficient and error-free data transmission across networks.

The term “network layer” may be used herein to refer to the third layer in the OSI model, which is responsible for determining the physical path data takes across a network. Network nodes that implement the network layer may manage packet forwarding operations, which may include routing the data packets through intermediate routers and ensuring that the data packets are transferred between source and destination nodes. Protocols such as Internet Protocol (IP) and Internet Control Message Protocol (ICMP) operate at the network layer to support communication between different networks and allow internetworking.

The term “transport layer” may be used herein to refer to the fourth layer in the OSI model, which is responsible for end-to-end communication and reliable data transfer between devices over a network. Network nodes that implement the transport layer may manage data segmentation, error detection, flow control, and retransmission of lost packets. Protocols associated with the transport layer include Transmission Control Protocol (TCP) and User Datagram Protocol (UDP), which manage the flow of data between network nodes.

The term “application layer” may be used herein to refer to the seventh and topmost layer in the OSI model. Network nodes that implement the application layer may interface directly with end-user software and/or may be responsible for providing network services to applications such as web browsers, email clients, and file transfer utilities. These network nodes may handle communication between software applications and the underlying network infrastructure through protocols like Hypertext Transfer Protocol (HTTP), File Transfer Protocol (FTP), and Simple Mail Transfer Protocol (SMTP).

The term “application-specific tag” may be used herein to refer to metadata included in an IP packet that includes information identifying the application, service, or software component associated with the data flow associated with the data packet. Application-specific tags may include details that network devices may use for classifying, routing, prioritizing, or otherwise managing packets based on their originating or destination application. Examples of application-specific tags may include unique identifiers linked to software programs, application-layer protocols, microservices, or operational services on client or server devices. In some embodiments, application-specific tags may be dynamically generated from metadata such as transport layer details, application data fields, predefined rules, or a combination thereof.

The term “session-specific tag” may be used herein to refer to metadata included in an IP packet that identifies a communication session or data flow between network endpoints. A session-specific tag may include session identifiers, flow metadata, timestamps, or contextual markers that could be used to aid in tracking and managing packet flows within an ongoing exchange of data. In some embodiments, session-specific tags may be generated dynamically based on session management protocols, transport layer metadata (e.g., source and destination IP addresses, port numbers, etc.), encryption keys, or other session-related information.

Various embodiments disclosed herein may include Internet Protocol (IP) packet tagging solutions that embed application-specific and session-specific metadata directly into IP packets. Related IP protocols, such as those defined in RFC 8200 for IPv6 and RFC 791 for IPv4, do not natively support application-specific or session-specific tagging within packet headers or payloads. This lack of native tagging presents several technical challenges for network administrators who need granular traffic analysis. Some embodiments address these limitations of conventional solutions by configuring a processing system in a network node to modify the IP protocol to allow packets to be tagged with specific metadata.

Due to the absence of native tagging capabilities in IP packets, related solutions fail to adequately associate traffic with its application or session context. As a result, most related solutions rely on external software to analyze network traffic. These external tools often use packet sampling techniques that result in incomplete data, inaccuracies, and delays caused by post-processing. As a result, these external tools may complicate network management, especially in real-time environments in which immediate insights are important for identifying security risks, performance bottlenecks, or other critical issues. These complications may reduce the effectiveness of traffic analysis and/or may cause delays in addressing network anomalies.

Some embodiments may include network nodes equipped with processing systems configured to overcome the above-described limitations of conventional solutions by embedding application-specific and session-specific tags into IP packet headers or payloads. A processing system may analyze traffic class and flow label fields in IPv6 packets or add extension headers and options for IPv4 packets, following IETF standards like RFC 8200 and RFC 6437. These modifications may allow the processing system to perform direct in-packet tagging operations that allow metadata related to each packet's source, destination, and purpose to be readily accessible for analysis and routing.

In some embodiments, the processing system may be configured to improve network performance by allowing real-time traffic analysis and routing based on application and session context. The processing system may dynamically track active sessions to continuously update flow metadata and ensure that each IP packet carries the appropriate tag. By embedding tags at the network layer, various embodiment processing system may enhance security and allow administrators to quickly identify anomalies, unauthorized access attempts, or malicious traffic. The processing system may improve traffic prioritization by allowing network devices to classify, route, and process packets with greater efficiency.

In some embodiments, the processing system may be configured to streamline packet handling across network components such as routers, firewalls, and switches. By embedding application-specific and session-specific tags within the packet structure, the processing system may reduce the need for deep packet inspection and decrease reliance on post-processing operations that slow traffic flow. This may result in faster data transmissions, improved resource allocation, and increased overall network efficiency.

In some embodiments, the processing system may be configured to use existing IETF standards with the necessary modifications to support enhanced tagging functionality to support compatibility with current networking infrastructures while delivering substantial improvements in traffic analysis, security, and network management.

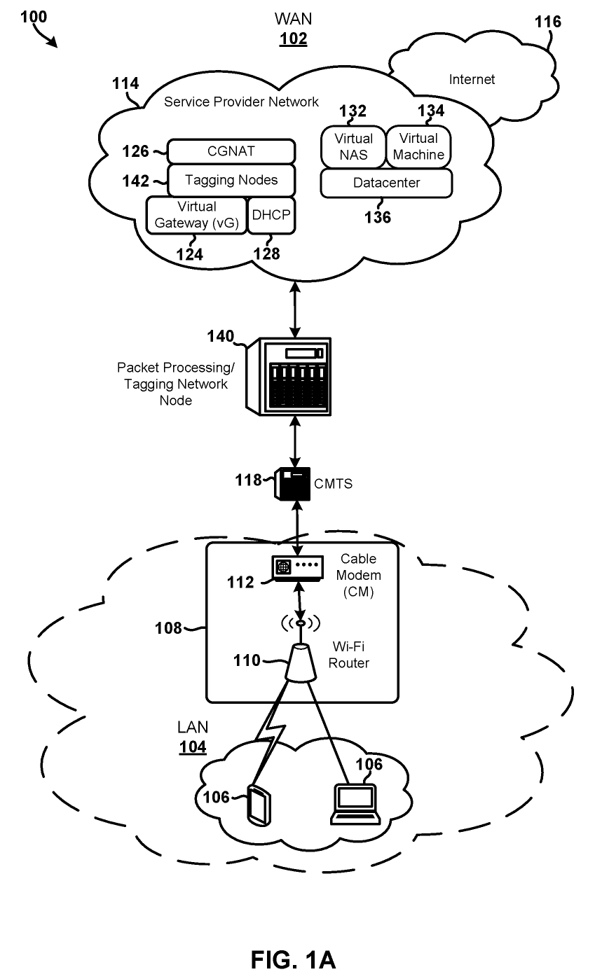

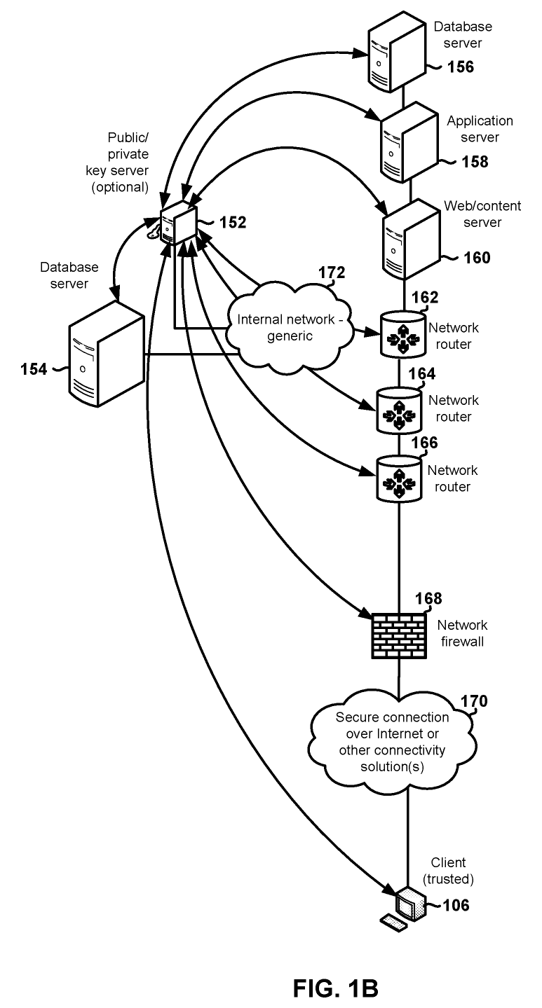

FIGS. 1A and 1B illustrate simplified examples of a network 100 suitable for implementing application-specific and session-specific tagging of IP packets in accordance with some embodiments. It should be understood that these figures are presented to provide a high-level overview of the network architecture and key components involved in the tagging operations and are not intended to depict every technology or element in the network. In some embodiments, the network components illustrated in FIGS. 1A and/or 1B may implement mechanisms to embed application- and session-specific tags within IP packets to enhance traffic analysis, management, and security.

In the example illustrated in FIG. 1A, the network 100 that includes a wide area network (WAN) 102, a local area network (LAN) 104, user equipment (UE) 106, and customer premises equipment (CPE) 108 that includes a Wi-Fi router 110 and a cable modem (CM) 112. The CPE 108 may connect the UE 106 to a service provider network 114 via a cable modem termination system (CMTS) 118 to allow the UE 106 to access services over the WAN 102 and Internet 116.

In some embodiments, the network 100 may also include packet processing/tagging network node 140 connected to the CMTS 118 and the WAN 102. The packet processing/tagging network node 140 may be configured to insert application-specific and/or session-specific metadata into IP packet headers or payloads. This tagging may improve network traffic management and security by allowing the source, destination, and purpose of each packet to be readily identified.

In some embodiments, the service provider network 114 may include any or all of a virtual gateway (vG) 124, carrier-grade network address translation (CGNAT) 126, dynamic host configuration protocol (DHCP) server 128, virtual network-attached storage (NAS) 132, virtual machines (VM) 134, and/or other include virtual components hosted within a data center 136.

In some embodiments, the service provider network 114 may include a tagging node 142 that is configured to work with other components, such as the vG 124, CGNAT 126, and DHCP server 128, to assign and manage IP tags. The tagging node 142 may embed metadata into packets as they traverse the WAN 102 for real-time analysis of data flows, including the use of traffic class and flow label fields as defined in IETF standards like RFC 8200 and RFC 6437.

In some embodiments, the virtual components (e.g., virtual NAS 132, virtual machines 134, etc.) may be configured to manage metadata related to tagged packets and support efficient handling of large-scale traffic for real-time tagging.

In some embodiments, the packet processing/tagging network node 140 and/or the tagging node 142 may be configured to perform real-time tagging operations that allow network administrators to classify traffic by application and session to enhance security monitoring and management without requiring external tools for packet sampling.

In some embodiments, the tagging node 142 may be configured to work with other network components (e.g., vG 124 and CGNAT 126, etc.) to facilitate traffic routing and manage the association of tags with IP packets. For example, embedded processing systems within the tagging nodes 142 may perform various operations to make sure that each packet is properly tagged before it enters or exits the service provider network 114.

In some embodiments, the network may include fallback mechanisms that offload tagging operations to virtualized infrastructure within the data center 136 if the packet processing/tagging network node 140 or tagging node 142 cannot perform their functions. For example, VMs 134 and virtual NAS 132 may handle tagging and metadata management to ensure uninterrupted traffic tagging in the event of a failure.

FIG. 1B illustrates additional components in the network 100 may include a public/private key server 152, database servers 154, 156, application server 158, web/content server 160, network routers 162, 164, 166, and a network firewall 168 connected to UE 106 via a secure connection 170. Network routers 162 and 164 may connect to the public/private key server 152 via an internal network 172.

The public/private key server 152 may be configured to manage cryptographic keys for secure communication between network nodes and client devices, such as UE 106. The public/private key server 152 may generate, store, and distribute keys to prevent unauthorized access to sensitive data and support authentication protocols to establish secure connections.

The database servers 154 and 156 may store and manage data, including session metadata and user information associated with tagged IP packets. The database servers 154 and 156 may also perform high-speed read/write operations and/or may include failover mechanisms that ensure data integrity.

The application server 158 may be configured to host network applications that interact with UE 106 or other network components. These applications may include web services or SaaS platforms that rely on database servers 154, 156. The application server 158 may also analyze data generated by tagging operations to provide insights into network performance and security.

The web/content server 160 may be configured to deliver web content to client devices such as UE 106. In some embodiments, the web/content server 160 may integrate with the tagging system to associate content requests with tags for optimization and analysis.

The network routers 162, 164, and 166 may be configured to route IP packets between network components. They may recognize and use embedded application-specific and session-specific metadata to improve routing efficiency and traffic flow. In some embodiments, one or more of the network routers 162, 164, and 166 may include packet inspection capabilities to further analyze tagged data.

The network firewall 168 may be configured to monitor network traffic, block unauthorized access, and detect malicious activity. In some embodiments, the network firewall 168 may be integrated with the tagging system and/or configured to perform security checks based on embedded metadata (e.g., packet source, destination, and application context, etc.).

The secure connection 170 may use encryption protocols, such as Transport Layer Security (TLS) or Internet Protocol Security (IPsec), to protect the integrity of transmitted data. The internal network 172 may link network components such as the public/private key server 152, database servers 154, 156, and application server 158. In some embodiments, the internal network 172 may be isolated from external traffic and configured to provide a secure environment for tagging and data processing operations.

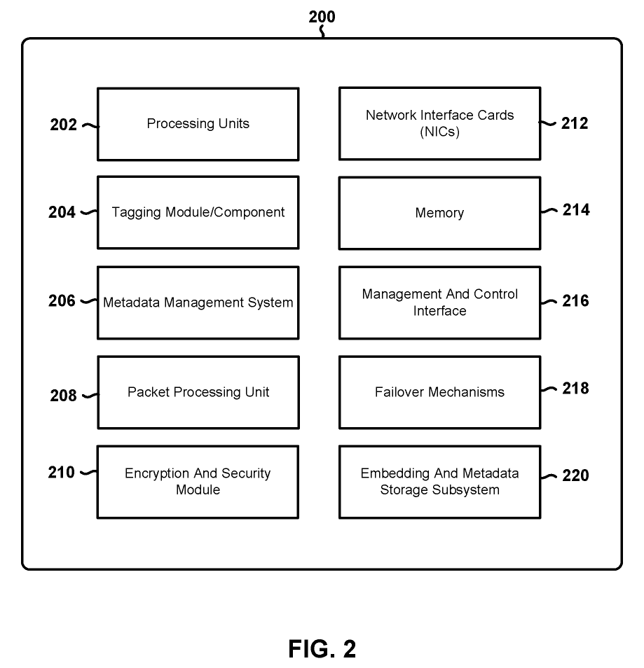

FIG. 2 is a component block diagram illustrating example components that could be included in a network node or system 200 configured to perform tagging operations that add application-specific and session-specific information to IP packets in accordance with some embodiments. In the example illustrated in FIG. 2, the system 200 includes processing units 202, a tagging module/component 204, a metadata management system 206, a packet processing unit 208, an encryption and security module/component 210, network interface cards (NICs) 212, memory 214, a management and control interface 216 component, failover mechanisms 218, and an embedding and metadata storage subsystem 220.

The processing units 202 may include processing systems configured to execute the instructions necessary to perform real-time packet tagging and metadata management operations. These instructions may include handling incoming packets, determining their application and session context, assigning appropriate tags, and managing secure communication. The processing units may coordinate the functionality of other components (e.g., tagging module, packet processing unit, metadata system, etc.). Examples of processing units 202 include general-purpose central processing units (CPUs), network processors, or dedicated hardware accelerators such as field-programmable gate arrays (FPGAs) or application-specific integrated circuits (ASICs). These components may be enhanced for high-speed network data handling, encryption, and complex packet tagging operations in real time.

The tagging module/component 204 may be configured to inspect each incoming IP packet and determine whether a tag is present. If no tag is detected, the module/component 204 may assign an application-specific tag or session-specific tag based on packet metadata, including source, destination, and flow characteristics. The tagging module/component 204 may also be configured to embed these tags into the packet's header or payload without disrupting existing IP protocol functionalities.

The metadata management system 206 may be configured to maintain a database or table that associates tags with metadata, including information such as application identifiers, session states, source and destination IP addresses, and flow labels. The metadata management system 206 may update this table dynamically as sessions are initiated and terminated to provide real-time tagging data to the tagging module/component 204.

The metadata management system 206 may be configured to maintain a dynamic table or database that stores metadata associated with tagged packets, including application-specific information, session context, flow labels, and traffic classes. The metadata management system 206 may provide the necessary context for tagging and/or information that allows any ongoing session or application flows to be tracked and available for subsequent packet handling operations.

The packet processing unit 208 may be configured to handle the reception, modification, and forwarding of IP packets. The packet processing unit 208 may be configured to work in conjunction with the tagging module/component 204 to ensure that packets are processed correctly, with their tags embedded, and forwarded to the appropriate destination based on the network routing protocols.

The packet processing unit 208 may be configured to manage the flow of IP packets through the network node. The packet processing unit 208 may interact with the tagging module to modify the packet's header or payload by embedding tags and forwarding packets to the correct destination. The packet processing unit 208 may also process the packets in accordance with security and performance policies for enhanced traffic routing.

The encryption and security module/component 210 may be configured to handle cryptographic operations related to packet security, such as encrypting the packet payload or headers, verifying the integrity of the tags embedded within packets, and performing secure transmission between network nodes. The encryption and security module/component 210 may interface with the public/private key infrastructure for secure key management and authentication.

The NICs 212 may be configured to handle the physical and data link layers of the communication process. The NICs 212 may allow for the transmission and reception of IP packets across network interfaces and allow the system to communicate with other network components and devices. The NICs 212 may be used for maintaining high-speed data transfers, low-latency packet handling, and real-time packet inspection for tagging.

The memory 214 may include both volatile memory (e.g., RAM) for temporary data storage and non-volatile memory (e.g., SSDs or HDDs) for storing metadata tables, system configurations, and historical session logs. The memory 214 may be used to buffer incoming packets, store session-specific data, and ensure that the metadata management system can access and update relevant information dynamically.

The management and control interface 216 component may be configured to allow network administrators to manage, configure, and monitor the tagging system. The interface may provide tools for setting tagging rules, analyzing network traffic patterns, and viewing metadata associated with active sessions. The management and control interface 216 may also include diagnostic and logging capabilities for troubleshooting issues that arise during packet tagging or transmission.

The failover mechanisms 218 may be configured to support continuous operation of the network node in the event of component failures. The failover mechanisms 218 may include redundant processing units, backup metadata storage systems, or virtualized environments that take over packet tagging and processing tasks when primary systems encounter issues. The failover mechanisms 218 may help maintain uninterrupted traffic tagging and transmission even in the event of hardware or software malfunctions.

The embedding and metadata storage subsystem 220 may be configured to store and manage the actual tags embedded into IP packets and their associated metadata. The embedding and metadata storage subsystem 220 may be configured to ensure that session-specific and application-specific information is preserved and may be retrieved or referenced during packet inspection or auditing processes. In some embodiments, the embedding and metadata storage subsystem 220 may include high-speed data storage that facilitates real-time tagging and metadata retrieval operations.

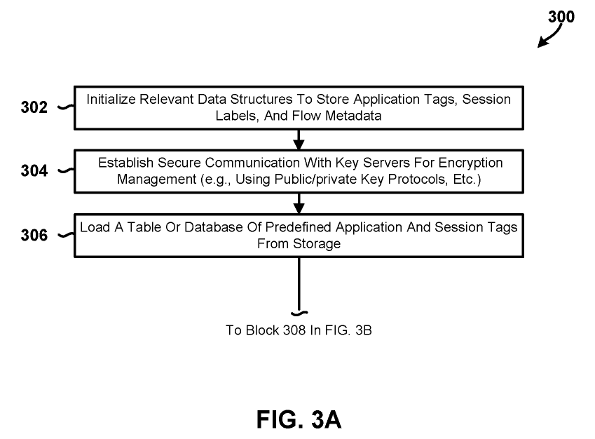

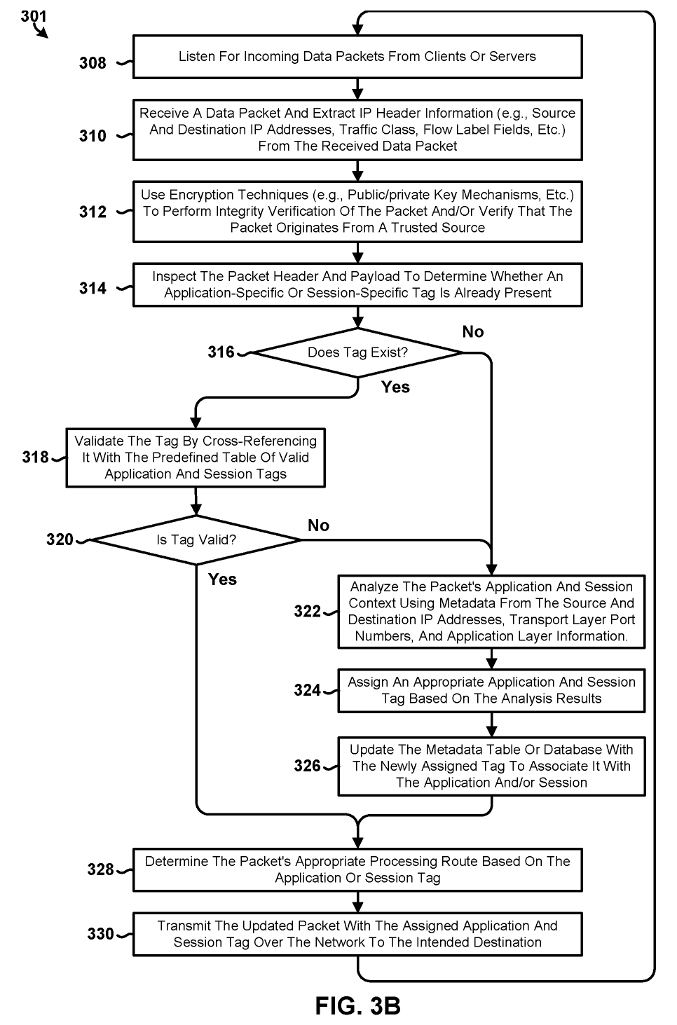

FIGS. 3A and 3B are process flow diagrams illustrating methods 300, 301 of tagging Internet Protocol (IP) packets with application-specific and session-specific information in a network communication system in accordance with some embodiments. With reference to FIGS. 1A-3B, methods 300, 301 may be performed in a network node by a processing system encompassing one or more components or subsystems discussed in this application. Means for performing the functions of the operations in methods 300, 301 may include a processing system including one or more processors and other components described herein. Further, one or more processors of a processing system may be configured with software or firmware to perform some or all of the operations of methods 300, 301. To encompass the alternative configurations enabled in various embodiments, the hardware implementing any or all methods 300, 301 is referred to herein as a “processing system.”

Referring to FIG. 3A, in block 302, the processing system may initialize data structures to store application tags, session labels, and flow metadata. In block 304, the processing system may establish secure communication with key servers for encryption management (e.g., using public/private key protocols, etc.). In block 306, the processing system may load a table or database of predefined application and session tags from storage. The table/database may include the IP subnets, flow labels, and traffic class details associated with specific applications and sessions.

Referring to FIG. 3B, in block 308, the processing system may listen for incoming data packets from clients or servers.

In block 310, the processing system may receive a data packet and extract the IP header information, including source and destination IP addresses, traffic class, and flow label fields as defined in RFC 8200, RFC 6437, and RFC 791. In some embodiments, the processing system may also retrieve additional details from the transport layer (e.g., port numbers) and application layer to determine whether the packet is associated with a particular session or application.

In block 312, the processing system may perform integrity verification of the packet using encryption methods (e.g., public/private key mechanisms, etc.) and verify that the packet originates from a trusted source (e.g., by checking the client or server identification against a cryptographic hash stored in the database, etc.).

In block 314, the processing system may inspect the packet header and payload to determine in block 316 whether the packet includes an application-specific tag or session-specific tag.

In response to determining that an application- or session-specific tag exists (i.e., determination block 316 = “Yes”), the processing system may validate the tag in block 318. In some embodiments, validating the tag in block 318 may include cross-referencing the tag with the predefined table of valid application and session tags to determine in block 320 whether the tag is valid.

In some embodiments, the predefined table of valid application-specific tags and session-specific tags may be a dynamically updated data structure stored in memory or a database that includes entries that associate each tag with its corresponding application, session, or flow context. For example, the table may store mappings of application-specific tags to unique application identifiers, protocol types, or service names, as well as mappings of session-specific tags to session identifiers, flow metadata, timestamps, or cryptographic keys. The table may also include additional metadata, such as tag expiration times, access control policies, and validation rules that govern the use of specific tags in network operations.

In some embodiments, the predefined table of valid application and session tags may be populated during system initialization or updated dynamically in response to changes in the network environment, such as the creation of new sessions or the deployment of new applications. In some embodiments, the processing system may receive or retrieve updates to the table from centralized key servers, distributed metadata repositories, or other components responsible for managing application and session contexts.

In some embodiments, validating the application-specific tag or session-specific tag against the predefined table of valid application-specific tags and session-specific tags in block 318 may include performing a multi-step verification process that includes checking whether the tag exists in the table, verifying the associated metadata (e.g., application type, session parameters, or expiration time), and confirming that the tag complies with predefined validation rules. In some embodiments, the processing system may use cryptographic methods, such as digital signatures or hash-based message authentication codes (HMAC), to verify the integrity and authenticity of the tag. In some embodiments, the validation operations may include querying external systems, such as distributed key servers or metadata registries, to confirm the legitimacy of the tag and retrieve updated validation criteria.

In some embodiments, the processing system may be configured to extract metadata associated with the validated application-specific tag or the validated session-specific tag. For example, the processing system may retrieve information such as the application or session type, flow characteristics, quality of service (QoS) parameters, and security attributes from the predefined table or an external metadata store. This metadata may include details that could be used for traffic prioritization, performance analysis, or compliance with network policies. The extracted metadata may also provide context for downstream packet processing, such as assigning the packet to a specific processing queue or applying encryption protocols for secure transmission.

In some embodiments, the processing system may be configured to determine a processing route based on the extracted metadata and send the received data packet to its intended destination using the determined processing route. For example, the processing system may analyze the metadata to assign a priority level to the packet, select an optimized routing path, or apply traffic shaping techniques. In some embodiments, the processing system may be configured to use the metadata to enforce security policies, such as by directing the packet through specific firewalls or intrusion detection systems before delivery. In some embodiments, the processing system may dynamically adjust the processing route based on real-time network conditions, such as congestion levels or resource availability.

In response to determining that the packet does not include a tag (i.e., determination block 316 = “No”) and/or in response to determining that the tag is not valid (i.e., determination block 320 = “No”), the processing system may analyze the packet for context assignment in block 322. This context assignment may include examining metadata such as the source and destination IP addresses, transport layer port numbers, and application layer information to identify the application and session. For example, in block 322 the processing system may analyze the packet's application and session context using metadata from the source and destination IP addresses, transport layer port numbers, and application layer information.

In block 324, the processing system may assign an appropriate application and/or session tag based on the analysis results generated in block 322. In various embodiments, the processing system may assign the tag by performing any of a variety of available methods, including header concatenation, extension header, option field, or payload insertion. For example, the processing system may perform IPv6 header concatenation operations that include generating the tag by concatenating the traffic class and flow label fields in the IPv6 header (per RFC 6437). The processing system may perform extension header operations that include adding an application-specific tag or session-specific tag as an extension header in IPv6. The processing system may perform option field operations that include inserting the tag as an option in the packet header in IPv4. The processing system may perform payload insertion operations that include embedding the tag within the initial bytes of the packet payload such that the integrity of the IP protocol is preserved.

In block 326, the processing system may update the metadata table or database with the newly assigned tag. This context assignment may include examining metadata such as the source and destination IP addresses, transport layer port numbers, and application layer information to identify the application and session.

In block 328, the processing system may determine the packet's appropriate processing route based on the application-specific tag or session-specific tag. In some embodiments, the processing system may forward the packet to the next hop based on the network layer routing table. In some embodiments, the processing system may perform additional computations or transformations as required by the application's processing rules. In some embodiments, the processing system may prioritize or categorize the packet based on the tag (e.g., to allow network administrators to track performance and identify any potential security concerns, etc.). In some embodiments, the processing system may apply encryption protocols to secure the packet (e.g., so that the payload and any inserted tags comply with the network's security policies, etc.). In some embodiments, the processing system may apply hashing techniques to verify packet integrity and prevent tampering during transmission.

In block 330, the processing system may transmit the updated packet with the assigned application and session tag over the network to the intended destination. In some embodiments, the processing system may maintain session consistency by ensuring that the same tag is applied throughout the communication flow.

In some embodiments, the processing system may continuously track ongoing sessions and update the flow metadata as required. In some embodiments, the processing system may perform various operations so that the correct application-specific tag or session-specific tag is applied to every IP packet transmitted for each active session. In some embodiments, the processing system may be configured to dynamically update the metadata table or database in response to session changes or new connections to reflect the current network conditions.

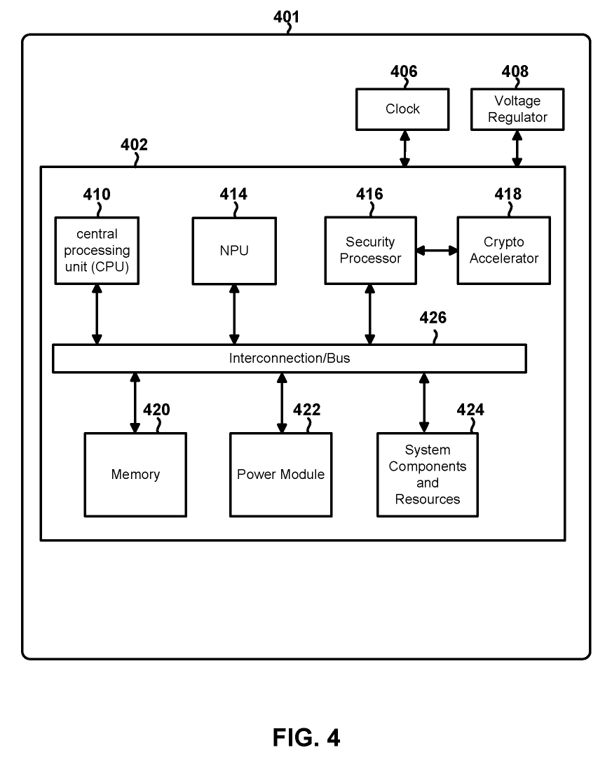

FIG. 4 is a component block diagram of an example computing system 401 suitable for implementing some embodiments of the application and session-specific tagging method for Internet Protocol (IP) packets. The computing system 401 may include a system on chip (SoC) 402 configured to perform packet tagging and metadata management within a network communication system. The SoC 402 may include various processing units, such as a central processing unit (CPU) 410, a network processor unit (NPU) 414, and a security processor 416, any or all of which may be interconnected and configured to perform the packet processing operations in accordance with the various embodiments. In some embodiments, the SoC 402 may also include a cryptographic accelerator 418 or a dedicated encryption engine configured to enhance the processing of security protocols, public/private key exchanges, and cryptographic hashing used for verifying packet integrity and managing secure communications. The SoC 402 may also include memory 420, a power module 422, and various system components and resources 424. The processors may communicate and share data through an interconnection/bus module 426, which may implement a high-performance bus architecture to allow seamless data transfer between processing units and memory components.

In some embodiments, the processors 410-418 within the SoC 402 may operate in a multicore configuration to handle complex tagging and packet routing operations. Each processor or core may manage specific aspects of the packet tagging operations, such as analyzing headers and payloads, assigning application-specific tag or session-specific tags, and updating the metadata table, thereby distributing the computational load and improving overall performance. The SoC 402 may be integrated into a heterogeneous processor cluster architecture to support coordinated operation across processors to allow the system to manage multiple packet flows and network sessions simultaneously.

The SoC 402 may further include an input/output module (not illustrated) for communicating with external resources, such as network interfaces for receiving IP packets and metadata from client and server applications and for transmitting the tagged packets and session data. These external resources may support connectivity with key servers, metadata tables, and other network devices and components for the tagging and routing processes. The input/output module may handle various network protocols and communication standards necessary for efficient packet tagging and metadata management.

The SoC 402 may also include system components, resources, and custom circuitry for managing data storage, flow label computations, and other specialized operations. For example, the system components and resources 424 may include memory controllers, data storage units (e.g., solid-state drives or flash memory), network interface controllers, and other components used to support the processing and transmission of tagged packets within the network. The system components and resources 424 may also include circuitry to interface with peripheral devices such as external security modules, input devices, and additional memory chips for high-performance packet processing.

In addition to the example computing system 401, the described embodiments may be implemented on a wide range of computing systems, including configurations with single processors, multicore processors, or clusters of processors. The flexibility of the described architecture allows the system to scale to meet the computational needs of various deployments and support efficient packet tagging and metadata management functionality in different network environments.

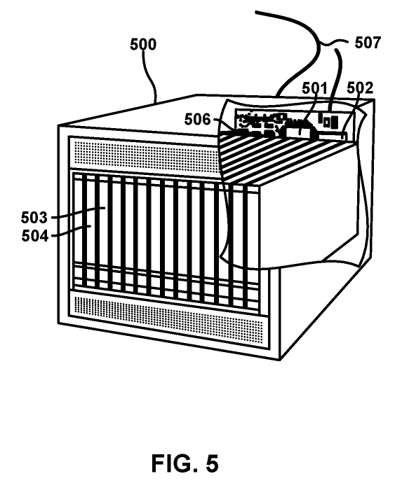

All or portions of some embodiments may be implemented in a network node, such as the server computing device 500 illustrated in FIG. 5. The server device 500 may include one or more processors 501 (e.g., multi-core processor, etc.) coupled to volatile memory 502, such as RAM, and a large capacity nonvolatile memory, such as a solid-state drive (SSD) 503. The server device 500 may also include additional storage interfaces such as USB ports and NVMe slots coupled to the processor 501. The server device 500 may include network access ports 506 coupled to the processor 501 that allow data connections through a network interface card (NIC) 504 and a communication network 507 (e.g., an Internet Protocol (IP) network) connected to other network elements.

For the sake of clarity and ease of presentation, the methods discussed in this application are presented as separate embodiments. While each method is delineated for illustrative purposes, it should be clear to those skilled in the art that various combinations or omissions of these methods, blocks, operations, etc. could be used to achieve a desired result or a specific outcome. It should also be understood that the descriptions herein do not preclude the integration or adaptation of different embodiments of the methods, blocks, operations, etc. from producing a modified or alternative result or solution. The presentation of individual methods, blocks, operations, etc. should not be interpreted as mutually exclusive, limiting, or as being required unless expressly recited as such in the claims.

The processors discussed in this application may be any programmable microprocessor, microcomputer, or a combination of multiple processor chips configured by software instructions (applications) to perform diverse functions, including those of the various embodiments described herein. Computing devices often include multiple processors, with dedicated processors for specific tasks. Software applications may be stored in the internal memory before being accessed and executed by the processor. Modern processors may include extensive internal memory, often augmented with fast access cache memory, to efficiently store and process application software instructions.

Implementation examples are described in the following paragraphs. While some of the following implementation examples are described in terms of example methods, further example implementations may include: the example methods discussed in the following paragraphs implemented by a computing system including a processing system configured (e.g., with processor-executable instructions) to perform operations of the methods of the following implementation examples; and the example methods discussed in the following paragraphs may be implemented as a non-transitory processor-readable storage medium having stored thereon processor-executable instructions configured to cause a processing system of a computing system to perform the operations of the methods of the following implementation examples.

Example 1. A method for tagging Internet Protocol (IP) packets with application-specific and session-specific information in a network communication system, the method including: receiving a data packet from a client or server; extracting header information from the received data packet; and determining whether the received data packet includes an application-specific tag or session-specific tag.

Example 2: The method of example 1, further including in response to determining that the received data packet does not include the application-specific tag or session-specific tag: analyzing the received data packet to determine an application-specific context and session-specific context based on source and destination IP addresses, transport layer port numbers, and payload content; assigning a new application-specific tag or a new session-specific tag to the received data packet; updating the received data packet with the assigned application-specific tag or session-specific tag; determining an appropriate processing route based on the assigned application-specific tag or session-specific tag; and sending the received data packet to its intended destination using the determined processing route.

Example 3: The method of example 2, wherein extracting header information from the received data packet comprises extracting a source IP address, a destination IP address, a traffic class, and flow label fields from the received data packet.

Example 4: The method of example 2, wherein the received data packet is an IPv6 data packet; and updating the received data packet with the assigned application-specific tag or session-specific tag comprises: concatenating traffic class and flow label fields in an IPv6 header of the received data packet.

Example 5: The method of example 2, wherein updating the received data packet with the assigned application-specific tag or session-specific tag comprises: adding an extension header that includes the application-specific tag or the session-specific tag to the received data packet.

Example 6: The method of example 2, wherein updating the received data packet with the assigned application-specific tag or session-specific tag comprises: inserting the application-specific tag or the session-specific tag into initial bytes of an IP packet payload of the received data packet.

Example 7: The method of example 2, further including: initializing network configuration settings and data structures for tracking application-specific tags, session-specific tags, and flow metadata; and establishing connections with key servers for encryption and secure assignment and validation of application-specific tags and session-specific tags.

Example 8: The method of example 2, further including: using a public/private key mechanism to verify integrity and source of the received data packet before determining whether the received data packet includes an application-specific tag or session-specific tag.

Example 9: The method of example 2, further including: using an encryption protocol to secure the received data packet before determining whether the received data packet includes an application-specific tag or session-specific tag.

Example 10: The method of example 2, further including: updating session states and flow metadata with the application-specific tag or session-specific tag for tracking ongoing sessions.

Example 11: The method of example 2, further including: tracking ongoing sessions and their corresponding application-specific tag or session-specific tags.

Example 12: The method of example 1, further including in response to determining that the received data packet includes the application-specific tag or session-specific tag: validating the application-specific tag or session-specific tag against a predefined table of valid application-specific tags and session-specific tags; and extracting metadata associated with the validated application-specific tag or the validated session-specific tag.

Example 13: The method of example 12, further including: determining an appropriate processing route based on the extracted metadata; and sending the received data packet to its intended destination using the determined processing route.

Example 14: The method of example 12, further including: performing a security check based on the extracted metadata to verify an authenticity or an integrity of the data packet in response to determining that the received data packet includes the application-specific tag or session-specific tag.

Example 15: The method of example 12, wherein extracting header information from the received data packet comprises extracting a source IP address, a destination IP address, a traffic class, and flow label fields from the received data packet.

Example 16: The method of example 12, wherein the received data packet is an IPv6 data packet.

Example 17: The method of example 12, further including: initializing network configuration settings and data structures for tracking application-specific tags, session-specific tags, and flow metadata; and establishing connections with key servers for encryption and secure assignment and validation of application-specific tags and session-specific tags.

Example 18: The method of example 12, further including: using a public/private key mechanism to verify integrity and source of the received data packet before determining whether the received data packet includes the application-specific tag or session-specific tag.

Example 19: The method of example 12, further including: using an encryption protocol to secure the received data packet before determining whether the received data packet includes the application-specific tag or session-specific tag.

Example 20: The method of example 12, further including: tracking ongoing sessions and their corresponding application-specific or session-specific tags.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A variety of memory types and technologies, both currently available and anticipated for future development, may be incorporated into systems and computing devices that implement the various embodiments. These memory technologies may include non-volatile random-access memories (NVRAM) such as magnetoresistive RAM (MRAM), resistive random-access memory (ReRAM or RRAM), phase-change memory (PCM, PC-RAM, or PRAM), ferroelectric RAM (FRAM), spin-transfer torque magnetoresistive RAM (STT-MRAM), and three-dimensional cross point (3D XPoint) memory. Non-volatile or read-only memory (ROM) technologies may also be included, such as programmable read-only memory (PROM), field programmable read-only memory (FPROM), and one-time programmable non-volatile memory (OTP NVM). Volatile random-access memory (RAM) technologies may further be utilized, including dynamic random-access memory (DRAM), double data rate synchronous dynamic random-access memory (DDR SDRAM), static random-access memory (SRAM), and pseudostatic random-access memory (PSRAM). In addition, systems and computing devices implementing these embodiments may use solid-state non-volatile storage mediums, such as FLASH memory. The aforementioned memory technologies may store instructions, programs, control signals, and/or data for use in computing devices, system-on-chip (SoC) components, or other electronic systems. Any references to specific memory types, interfaces, standards, or technologies are provided for illustrative purposes and do not limit the claims to any particular memory system or technology unless explicitly recited in the claim language.

The foregoing method descriptions and the process flow diagrams are provided merely as illustrative examples and are not intended to require or imply that the blocks of the various aspects must be performed in the order presented. As may be appreciated by one of skill in the art the order of steps in the foregoing aspects may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithmic steps described in connection with the aspects disclosed herein may be implemented as electronic hardware, computer software, or combinations of both. To clearly illustrate the interchangeability of hardware and software, various components, blocks, modules, circuits, and steps have been described in terms of their functionality. Whether such functionality is implemented as hardware or software may depend on the specific application and the design constraints of the overall system. Skilled artisans may implement the described functionality in different ways for each particular application, and such implementation decisions should not be interpreted as limiting or altering the scope of the claims unless explicitly recited in the claim language.

The hardware used to implement the various illustrative logics, logical blocks, modules, and circuits described in connection with the embodiments disclosed herein may include or be performed by a general-purpose processor, a digital signal processor (DSP), an application-specific integrated circuit (ASIC), a field-programmable gate array (FPGA), a graphics processing unit (GPU), a tensor processing unit (TPU), or other programmable logic devices, discrete gate or transistor logic, discrete hardware components, or any combination thereof, designed to perform the functions described. A general-purpose processor may be a microprocessor, or alternatively, it may be any conventional processor, controller, microcontroller, or state machine. A processor may also be implemented as a combination of computing devices, such as a DSP combined with a microprocessor, multiple microprocessors, one or more microprocessors used in conjunction with a DSP core, a GPU, or AI accelerators such as TPUs. Alternatively, some operations or methods may be performed by circuitry designed specifically for a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module that resides on a non-transitory computer-readable or processor-readable storage medium. Non-transitory computer-readable or processor-readable storage media include any storage media that may be accessed by a computer or processor. By way of example, but not limitation, such non-transitory computer-readable or processor-readable media may include RAM, ROM, EEPROM, flash memory, SSDs, NVMe drives, 3D NAND flash, or any other medium capable of storing program code in the form of instructions or data structures that may be accessed by a computer. Cloud-based storage solutions, including infrastructure-as-a-service (IaaS) platforms, may provide scalable and distributed options for storing and accessing program code. In addition, the operations of a method or algorithm may reside as one or more sets of instructions or code on a non-transitory processor-readable or computer-readable medium, which may be incorporated into a computer program product. Emerging technologies, such as quantum computing storage media and blockchain-based storage solutions, may enhance data integrity and security. AI and ML-enhanced hardware accelerators, such as GPUs, TPUs, and other dedicated processing units, may be used to efficiently execute complex algorithms.

The preceding description of the disclosed aspects is provided to enable any person skilled in the art to make or use the claims. Various modifications to these aspects may be apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

What is claimed is:

1. A method for tagging Internet Protocol (IP) packets with application-specific and session-specific information in a network communication system, comprising:
receiving a data packet from a client or server;
extracting header information from the received data packet; and
determining whether the received data packet includes an application-specific tag or session-specific tag.

2. The method of claim 1, further comprising:
in response to determining that the received data packet does not include the application-specific tag or session-specific tag:
analyzing the received data packet to determine an application-specific context and session-specific context based on source and destination IP addresses, transport layer port numbers, and payload content;
assigning a new application-specific tag or a new session-specific tag to the received data packet;
updating the received data packet with the assigned application-specific tag or session-specific tag;
determining an appropriate processing route based on the assigned application-specific tag or session-specific tag; and
sending the received data packet to its intended destination using the determined processing route.

3. The method of claim 2, wherein extracting header information from the received data packet comprises extracting a source IP address, a destination IP address, a traffic class, and flow label fields from the received data packet.

4. The method of claim 2, wherein:
the received data packet is an IPv6 data packet; and
updating the received data packet with the assigned application-specific tag or session-specific tag comprises:
concatenating traffic class and flow label fields in an IPv6 header of the received data packet.

5. The method of claim 2, wherein updating the received data packet with the assigned application-specific tag or session-specific tag comprises:
adding an extension header that includes the application-specific tag or the session-specific tag to the received data packet.

6. The method of claim 2, wherein updating the received data packet with the assigned application-specific tag or session-specific tag comprises:
inserting the application-specific tag or the session-specific tag into initial bytes of an IP packet payload of the received data packet.

7. The method of claim 2, further comprising:
initializing network configuration settings and data structures for tracking application-specific tags, session-specific tags, and flow metadata; and
establishing connections with key servers for encryption and secure assignment and validation of application-specific tags and session-specific tags.

8. The method of claim 2, further comprising using a public/private key mechanism to verify integrity and source of the received data packet before determining whether the received data packet includes an application-specific tag or session-specific tag.

9. The method of claim 2, further comprising using an encryption protocol to secure the received data packet before determining whether the received data packet includes an application-specific tag or session-specific tag.

10. The method of claim 2, further comprising updating session states and flow metadata with the application-specific tag or session-specific tag for tracking ongoing sessions.

11. The method of claim 2, further comprising tracking ongoing sessions and their corresponding application-specific tag or session-specific tags.

12. The method of claim 1, further comprising:
in response to determining that the received data packet includes the application-specific tag or session-specific tag:
validating the application-specific tag or session-specific tag against a predefined table of valid application-specific tags and session-specific tags; and
extracting metadata associated with the validated application-specific tag or the validated session-specific tag.

13. The method of claim 12, further comprising:
determining an appropriate processing route based on the extracted metadata; and
sending the received data packet to its intended destination using the determined processing route.

14. The method of claim 12, further comprising performing a security check based on the extracted metadata to verify an authenticity or an integrity of the data packet in response to determining that the received data packet includes the application-specific tag or session-specific tag.

15. The method of claim 12, wherein extracting header information from the received data packet comprises extracting a source IP address, a destination IP address, a traffic class, and flow label fields from the received data packet.

16. The method of claim 12, wherein the received data packet is an IPv6 data packet.

17. The method of claim 12, further comprising:
initializing network configuration settings and data structures for tracking application-specific tags, session-specific tags, and flow metadata; and
establishing connections with key servers for encryption and secure assignment and validation of application-specific tags and session-specific tags.

18. The method of claim 12, further comprising using a public/private key mechanism to verify integrity and source of the received data packet before determining whether the received data packet includes the application-specific tag or session-specific tag.

19. The method of claim 12, further comprising using an encryption protocol to secure the received data packet before determining whether the received data packet includes the application-specific tag or session-specific tag.

20. The method of claim 12, further comprising tracking ongoing sessions and their corresponding application-specific or session-specific tags.

21. A network node, comprising:
a processing system configured to:
receive a data packet from a client or server;
extract header information from the received data packet; and
determine whether the received data packet includes an application-specific tag or session-specific tag.

22. The network node of claim 21, wherein in response to determining that the received data packet does not include the application-specific tag or session-specific tag the processing system is further configured to:
analyze the received data packet to determine an application-specific context and session-specific context based on source and destination IP addresses, transport layer port numbers, and payload content;
assign a new application-specific tag or a new session-specific tag to the received data packet;
update the received data packet with the assigned application-specific tag or session-specific tag;
determine an appropriate processing route based on the assigned application-specific tag or session-specific tag; and
send the received data packet to its intended destination using the determined processing route.

23. The network node of claim 22, wherein the processing system is further configured to extract header information from the received data packet by extracting a source IP address, a destination IP address, a traffic class, and flow label fields from the received data packet.

24. The network node of claim 22, wherein:
the received data packet is an IPv6 data packet; and
the processing system is further configured to update the received data packet with the assigned application-specific tag or session-specific tag by:
concatenating traffic class and flow label fields in an IPv6 header of the received data packet.

25. The network node of claim 22, wherein the processing system is further configured to update the received data packet with the assigned application-specific tag or session-specific tag by:
adding an extension header that includes the application-specific tag or the session-specific tag to the received data packet.

26. The network node of claim 22, wherein the processing system is further configured to update the received data packet with the assigned application-specific tag or session-specific tag by:
inserting the application-specific tag or the session-specific tag into initial bytes of an IP packet payload of the received data packet.

27. The network node of claim 22, wherein the processing system is further configured to
initializing network configuration settings and data structures for tracking application-specific tags, session-specific tags, and flow metadata; and
establishing connections with key servers for encryption and secure assignment and validation of application-specific tags and session-specific tags.

28. The network node of claim 22, wherein the processing system is further configured to use a public/private key mechanism to verify integrity and source of the received data packet before determining whether the received data packet includes an application-specific tag or session-specific tag.

29. The network node of claim 22, wherein the processing system is further configured to use an encryption protocol to secure the received data packet before determining whether the received data packet includes an application-specific tag or session-specific tag.

30. The network node of claim 22, wherein the processing system is further configured to update session states and flow metadata with the application-specific tag or session-specific tag for tracking ongoing sessions.

31. The network node of claim 22, wherein the processing system is further configured to track ongoing sessions and their corresponding application-specific tag or session-specific tags.

32. The network node of claim 21, wherein in response to determining that the received data packet includes the application-specific tag or session-specific tag the processing system is further configured to:
validate the application-specific tag or session-specific tag against a predefined table of valid application-specific tags and session-specific tags; and
extract metadata associated with the validated application-specific tag or the validated session-specific tag.

33. The network node of claim 32, wherein the processing system is further configured to:
determine an appropriate processing route based on the extracted metadata; and
send the received data packet to its intended destination using the determined processing route.

34. The network node of claim 32, wherein the processing system is further configured to perform a security check based on the extracted metadata to verify an authenticity or an integrity of the data packet.

35. The network node of claim 32, in response to determining that the received data packet includes the application-specific tag or session-specific tag the processing system is further configured to extract the header information from each received data packet by extracting a source Internet Protocol (IP) address, a destination IP address, a traffic class, and flow label fields from the received data packet.

36. The network node of claim 32, wherein in response to determining that the received data packet includes the application-specific tag or session-specific tag the processing system is further configured to receive the data packet from the client or server by receiving a IPv6 data packet.

37. The network node of claim 32, wherein in response to determining that the received data packet includes the application-specific tag or session-specific tag the processing system is further configured to:
initialize network configuration settings and data structures for tracking application-specific tags, session-specific tags, and flow metadata; and
establish connections with key servers for encryption and secure assignment and validation of application-specific tags and session-specific tags.

38. The network node of claim 32, wherein in response to determining that the received data packet includes the application-specific tag or session-specific tag the processing system is further configured to use a public/private key mechanism to verify integrity and source of the received data packet before determining whether the received data packet includes the application-specific tag or session-specific tag.

39. The network node of claim 32, wherein in response to determining that the received data packet includes the application-specific tag or session-specific tag the processing system is further configured to use an encryption protocol to secure the received data packet before determining whether the received data packet includes the application-specific tag or session-specific tag.

40. The network node of claim 32, wherein in response to determining that the received data packet includes the application-specific tag or session-specific tag the processing system is further configured to track ongoing sessions and their corresponding application-specific or session-specific tags.
